(19) United States
(12) Patent Application Publication
(10) Pub. No.: US 2004/0015486 A1
(43) Pub. Date: Jan. 22, 2004

(54) System and method for storing and retrieving data

(76) Inventors: Jiasen Liang, Scarborough (CA); Kin Ming Chan, Toronto (CA)

Correspondence Address: HOGAN & HARTSON LLP, ONE TABOR CENTER, SUITE 1500, 1200 SEVENTEEN ST., DENVER, CO, 80202, US

(21) Appl. No.: 10/198,350

(22) Filed: Jul. 19, 2002

(51) Int. Cl. G06F 17/30; G06F 7/00

(52) U.S. Cl. 707/3

(57) ABSTRACT

A system and method for storing and retrieving data. A graph data structure consisting of a set of nodes connected by a set of links is represented by a set of records. The records correspond to both a set of direct and indirect relationships between pairs of the sets of nodes. Additional information can be captured in the records regarding each of the pair of nodes specified and the relationship between the nodes. In some situations, the records contain information regarding the nodal distance between pairs of nodes. Where the graph data structure is hierarchical, the records can contain information indicating whether the parent node is a parent root node and whether the child node is a child leaf node.

### FIELD OF THE INVENTION

The present invention relates to a system and method for storing and retrieving data. More specifically, the present invention relates to a system and method for storing and retrieving data for graph data structures.

### BACKGROUND OF THE INVENTION

In enterprise information systems, graph data structures are often needed to represent hierarchical structural information. Graph data structures are characterized by a set of vertices, or nodes, connected by a set of edges, or links. For example, the enterprise internal organization hierarchies, the catalog and learning path hierarchies, the enterprise geographical region service and resource control hierarchies, and the enterprise product price policy hierarchies, are all suitable for representation using graph data structures. In these particular examples, the graph data structures are hierarchical. As will be appreciated by those of skill in the art, these hierarchical graph data structures are called quasi-trees because they have most of the features of tree data structures, but unlike traditional tree data structures, any node in the structure may have more than one parent node. One of the common features of the data structure in the enterprise information systems is that the data structure is relatively static, and the data stored is shared by many concurrent users.

Most of the routine operations against the graph structure are data retrievals, rather than the structure modifications. For example, it is more often a requirement to search the child organizations or browse the child catalogs in an enterprise information hierarchical structure, rather than adding a new organization or a new child catalog on a regular daily basis. In addition, since the data structures are shared by all enterprise employees and customers, fast, efficient data retrievals are an important feature.

The traditional graph presentation consists of two parts: node presentation and link presentation. Node presentation usually contains a node ID, name and other application-specific attributes. Link presentation captures the relationships among the nodes in the graph. The traditional way of representing such a data structure in a relational database is to use data links among adjacent graph nodes. Since the study of the efficiency of the graph search operation depends mainly on the node relationships, i.e., the link presentation, node presentation is omitted for purposes of this discussion. As is well understood by those of skill in the art, a relational database is good at representing data relations, but not at the relational sequences, as can be required in the above-described type of graph data structure. In the above-described graph data structure, for example, if it is required to search all grandchild nodes of any given node, each direct child node of the given node must be first retrieved. Then, the child nodes of each direct child node found in the first step are retrieved. This process is a repeated, iterative looping database search operation, requiring a significant period of time for completion.

Another typical operation for which the graph is utilized is as follows: given an organization node in a hierarchical organization graph, find the administrator of its direct parent organization or the super administrator of its root parent organization. Sometimes, in order to determine an administrator's management privileges over a given organization, the parent and child relationships between the administrator's organization and the given organization need to be determined against the hierarchical organization graph. Again, all of these checking processes involve looping database accesses in the traditional representation of the data model.

This disadvantage of the prior art can be seen from the following example using a traditional graph. The example code presented in Appendix 1 shows how a graph structure is represented in a relational database using standard structured query language (SQL) data definition language (DDL), a language used to create and delete (drop) tables and relationships in a standard SQL database.

As stated above, in order to find either parent nodes or child nodes of a given target node at layer n (where n−1, 2, 3 . . . ), the parent or child nodes at layer 1 need to be retrieved first. Then, the parent and child nodes at layer 2 can be searched based on the result nodes at parent or child layer 1. This process is repeated until the nodes at layer n are found. The sample code presented in Appendix 2 shows this search operation in pseudo Java code for a given target node, referred to therein as node “i”:

From the sample code in Appendix 2, it can be seen that two nested loops exist in the searching operation, with each inner loop using one database access. As is known by those of skill in the art, database access is relatively expensive and slow compared to in-memory data processing, even if the techniques of connection pooling and search statement pre-compiling are used. In addition, such delays can become more serious if the above search operation is called concurrently by hundreds and thousands of simultaneous users.

Some database management systems have proprietary commands that can help simplify the above search operation. For example, in the Oracle 8i database, searching the child nodes can be achieved using the Oracle SQL Plus command “start with . . . . connect by”. However, it should be noted that the supports are usually limited when facing different data retrieval requirements in the real applications (e.g., searching root/leaf nodes and check relationship etc.). Also, using the database proprietary commands would compromise the application code portability.

Although in most cases, the data retrieval from database can be sped up by using the techniques such as database connection pooling and query string pre-compiling, such an improvement is usually not enough to offset the loop searching delay, especially under the condition of heavy concurrent data searches. Nevertheless, the data retrieval delay becomes even more significant when the searched nodes are farther away from the given node.

Another known solution to the issue of poor responsiveness of such data retrievals is to bring the whole graph structure into memory at the time of system startup, so that the data retrieval can be done right in the memory afterwards. A problem associated with this solution appears when the solution is applied to the clustering environments. Once the data structure or a value in the structure is changed in one system of the clustering configuration, a suitable mechanism is needed to communicate the change to other systems in the same clustering environment. This, on one hand, involves extra effort and time for developing, debugging and maintaining the communication and synchronization software. On the other hand, the solution does not eliminate the looping of the data processing, which is actually the root cause of the issue. The improved performance of data retrieval comes only from taking advantage of fast memory speed, not from proper designs of the data model or the search operation.

It is, therefore, desirable to provide a data model that can ameliorate performance bottlenecks, while providing good application code portability.

### SUMMARY OF THE INVENTION

It is therefore an object of the invention to provide a novel system and method for modeling data for graph data structures that obviates or mitigates at least one of the above-identified disadvantages of the prior art.

In a first aspect of the invention, there is provided a system for storing and retrieving data, comprising: a database server having a database for storing a graph data structure; at least one client for retrieving a set of data from the graph data structure stored in the database; the database comprising a set of records, each of the records representing an individual relationship between a first node and a second node and specifying the first node, the second node and at least one characteristic of said individual relationship between said first node and said second node.

The at least one characteristic can include, but is not limited to, a distance metric, such as the nodal distance or the physical distance between the first and second nodes, a measure of financial cost with the individual relationship between the first and second nodes, and a measure of time associated with the individual relationship between the first and second nodes.

Each of the records can additionally comprise at least one characteristic of one or both of the first and second nodes.

In an implementation of the first aspect, each of the records represent one of a set of direct and indirect parent-child relationships of the graph data structure, where the first node is the parent node and the second node is the child node.

The records can include information about whether the parent node is a parent root node and whether the child node is a child leaf node.

In another implementation of the embodiment, the client can be an application server serving a number of other clients. Additionally, the client and the server can reside on a single physical machine or on a cluster of machines.

In another aspect of the invention, there is provided a system for storing and retrieving data, comprising: a database server having a database for storing a set of data from a graph data structure; at least one client for retrieving a subset of data from the graph data structure stored in the database; the database comprising a set of records, each of the records representing an individual parent-child relationship between a parent node and a child node and having a first field specifying the parent node, a second field specifying the child node, a third field specifying whether the parent node is a parent root node, a fourth field specifying whether the child node is a child leaf node and a fifth field specifying the nodal distance between the parent and child nodes.

In a third aspect of the invention, there is provided a method of storing data, comprising the steps: recording a set of direct node relationships between a set of nodes forming a graph data structure; recording a set of indirect node relationships between the set of nodes; and combining the set of direct node relationships and the indirect node relationships to form a database of direct and indirect node relationships.

In an implementation of the third aspect, each of the direct node relationships represents a relationship between a first node and a direct parent node of the first node and each of the indirect node relationships represents a relationship between a second node and an indirect parent node of the second node.

In fourth aspect of the invention, there is provided a method of adding a node to a graph data structure stored in a database, comprising the steps: retrieving from a database a first set of direct and indirect node relationships for a first set of nodes to which a new node is to be directly related; recording in the database a second set of indirect relationships between the new node and a second set of nodes related to said first set of nodes as indicated by said set of direct and indirect node relationships; and recording in the database a third set of direct relationships between the first set of nodes and the new node.

Each of the first, second and third sets of direct and indirect node relationships, each specifying a relationship between a first node and a second node, can additionally comprise at least one characteristic of the relationship between the first node and the second node.

The at least one characteristic can include a distance metric, such as the nodal distance or the physical distance, between the first and second nodes.

In an implementation of the fourth aspect, the graph data structure is hierarchical and the first, second and third sets of direct and indirect relationships represent direct and indirect parent-child relationships.

The database can additionally store at least one characteristic of each of the first, second and third sets of direct and indirect parent-child relationships. The at least one characteristic can include a distance metric, such as the nodal distance between the parent node and the child node.

The database can also store for each of the first, second and third sets of direct and indirect parent-child relationships at least one characteristic of the parent node, such as whether the parent node is a parent root node, and/or the child node, such as whether the child node is a child leaf node.

### BRIEF DESCRIPTION OF THE DRAWINGS

Preferred embodiments of the present invention will now be described, by way of example only, with reference to the attached Figures, wherein:

FIG. 1 shows a system for implementing the data model comprising a number of clients connecting to a server in accordance with an embodiment of the invention;

FIG. 2 shows a schematic representation of a number of hardware and logical components of the server of FIG. 1;

FIG. 3 shows a portion of an exemplary graph data structure that can be modeled in accordance with an embodiment of the invention;

FIG. 4 shows a set of relational information that is maintained by the system for a target node in accordance with an embodiment of the invention;

FIG. 5 is a table showing exemplary records in a database for the links shown in FIG. 4 in accordance with an embodiment of the invention;

FIG. 6 shows a flow chart of the method of adding a child leaf node to an existing graph data structure;

FIG. 7 shows a child leaf node that is to be added to a graph data structure;

FIG. 8 shows the relational information that is maintained by the system for an exemplary parent node of FIG. 7;

FIG. 9 shows the establishment of relationships between the newly-added child leaf node and the parent nodes of the parent nodes of FIG. 7;

FIG. 10 shows the establishment of the relationships of the child leaf node of FIG. 7 with a number of parent nodes; and

FIG. 11 shows a flow chart of the method of removing a child leaf node from a graph data structure.

### DETAILED DESCRIPTION OF THE INVENTION

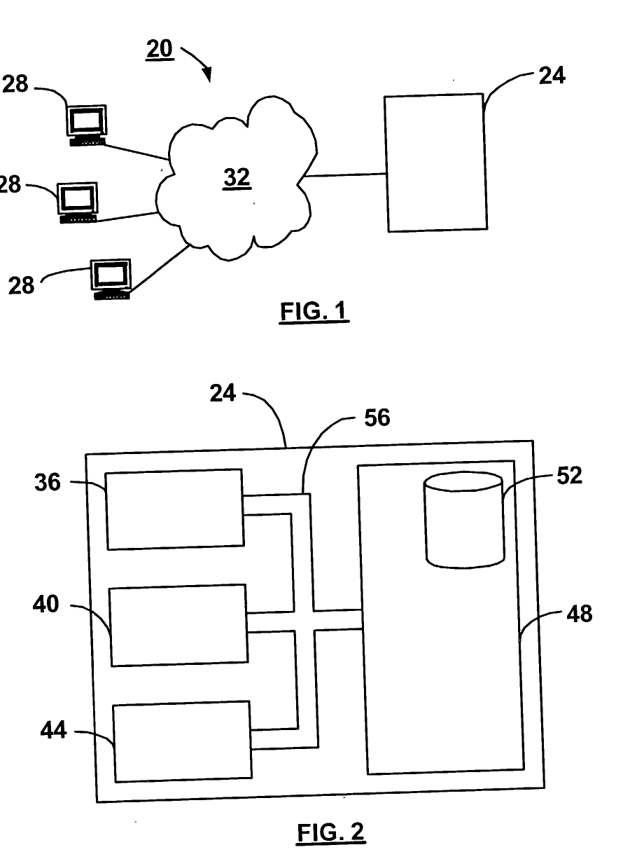

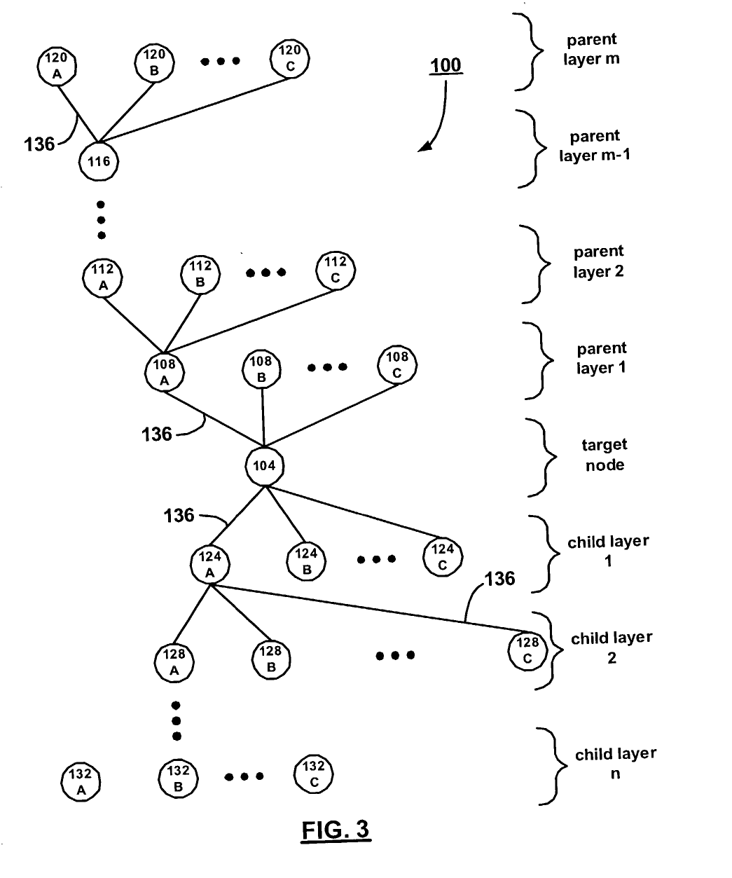

A system for storing and retrieving data in accordance with an embodiment of the invention is generally shown at 20 in FIGS. 1 and 2. System 20 is comprised of a server 24 to which a number of clients 28 are connected via communication medium 32. Server 24 is any server known in the art, such as the Sun Enterprise 10440 Server, sold by Sun Microsystems of Palo Alto, Calif. Server 24 generally includes a central processing unit 36, a random access memory 40, a computer network interface to allow server 24 to communicate over communication medium 32, and a data storage means 48 implementing a database 52, all interacting via bus 56. In an embodiment of the invention, server 24 executes commercial database server software, such as Oracle 8i; any computing device operable to maintain, search and process data records, however, can be suitable. Further, while server 24 is implemented on a single computing device in a present embodiment, it will be understood by those of skill in the art that server 24 can be implemented on a number of machines or in a clustering environment and database 52 can be maintained by a separate server or servers with which server 24 is in communication. Clients 28 are any computing devices known in the art (such as personal computers, network thin clients, mobile phones, personal digital assistants, etc.) that have a basic set of hardware resources, such as a central processing unit, random access memory, and input/output functionality. While clients 28 are shown accessing server 24 via communications medium 32, it is contemplated that a user accesses the functionality of the invention directly via server 24. Communication medium 32 can be any suitable network, such as the Internet or the like. In a presently preferred embodiment, communication medium 32 is the Internet.

Server 24 hosts software that interacts with database 52 for clients 28. The software can be of any kind that accesses data in a graph data structure. Examples of such software can include, but is not limited to:

corporate organizational databases where employees are grouped into units, divisions, regions, etc.;

product catalogs where products are grouped by category, region, reseller, distributor, etc.;

family tree organizers, that can be used, for example, for enabling scientists to link individuals who are known to have a genetic disease with others who have not exhibited symptoms of the disease but may be carriers thereof, in which case individuals can be represented by nodes and each node has two parent nodes; and

file systems where folders can be nested and files can be placed in any folder.

Other types of software will occur to those of skill in the art and are within the scope of the present invention.

During the course of operation, a variety of data retrievals may need to be performed on the data structure. In a present embodiment, these data retrievals take the form of SQL queries to database 52. Any of a variety of such referential operations can be performed, including, but not limited to, the following operations:

Given a node i, find all its child nodes.

Given a node i, find all its child nodes at any layer n, where n=l, 2, 3 . . .

Given a node i, find all its leaf nodes. That is, the child nodes of node i that don't have child nodes.

Given a node i, find all its parent nodes.

Given a node i, find all its parent nodes at any layer m, where m=1, 2, 3 . . .

Given a node i, find all its root nodes. That is, the child notes of node i that don't have parent nodes.

Given any two nodes i and j, check if they are directly or indirectly related. That is, check if i is j's direct or indirect parent or child, and vice versa.

At the time of configuration and on an ongoing basis, most applications of such a data structure will be modified. For most applications, such modifications typically consist of the addition and removal of child leaf nodes. Other modifications to the data structure that could be supported include, but are not limited to, the deletion of a node and some or all of its child nodes, the merging of two data structures and the insertion or removal of a node having child nodes without destroying the data structure therebelow.

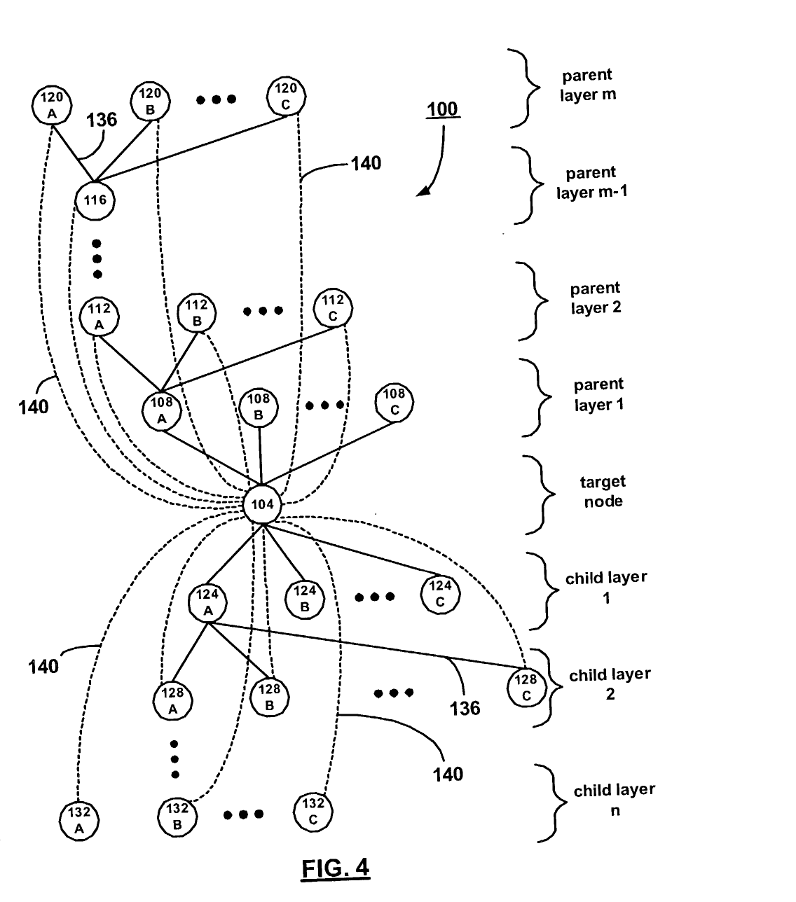

Now referring to FIG. 3, a portion of an exemplary graph data structure is shown generally as 100. An exemplary, or target, node 104 of graph data structure 100 is noted for purposes of illustration. Target node 104 is in direct child relation to a number of direct parent nodes, including direct parent nodes 108A, 108B and 108C. As used herein, the term “direct parent nodes 108” collectively refers to “direct parent nodes 108a, 108b and 108c”. This convention shall be used herein to apply to other items shown in the attached Figures. Again, for purposes of illustration, only the parents of direct parent node 108A are shown in FIG. 3, three of which are shown as 112A, 112B and 112C. Direct parent nodes 108B and 108C can, themselves, either be child nodes to other nodes or have no parent nodes. Nodes that are not child nodes of any other nodes are parent “root” nodes. Three exemplary top-level parent root nodes 120A, 120B and 120C are shown having a common child node 116. Parent root nodes 120 are separated from target node 104 by m−1 nodes.

Target node 104 is also in direct parental relation to a number of direct child nodes, including direct child nodes 124A, 124B and 124C. Direct child node 124A is shown having three exemplary child nodes 128A, 128B and 128C. While not shown, direct child nodes 124B and 124C can either, themselves, have child nodes or can be a child “leaf” node. (A child “leaf” node is a node without child nodes.) Three exemplary bottom-level child leaf nodes 132 are shown. Child leaf nodes 132 are separated from target node 104 by n−1 nodes. Direct parent-child relationships are shown generally as 136.

While target node 104 is shown as the only node in its level, it is contemplated that target node 104 can share this level with a number of other nodes.

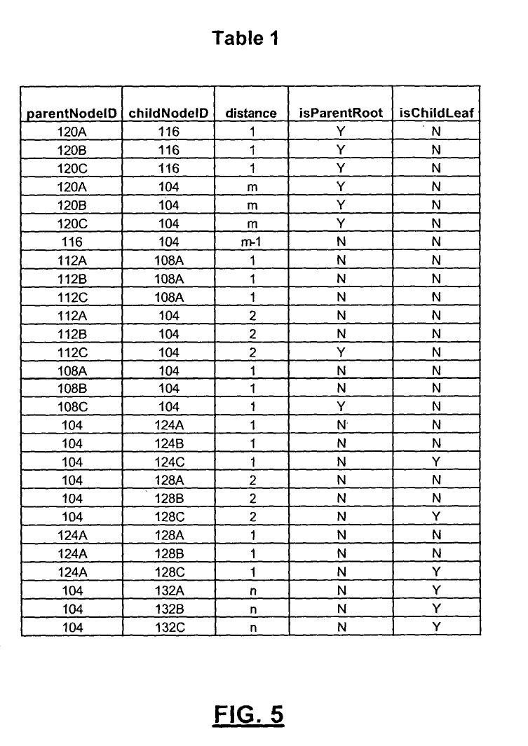

Now referring to FIG. 4, in addition to direct parent-child relationships 136, a set of indirect parent-child relationships 140 are shown linking nodes and their grandchildren nodes or their great-grandchild nodes, etc. Thus, indirect parent-child relationships 140 are shown between target node 104 and each of parent root nodes 120, the grandparent nodes 112 of target node 104, the grandchild nodes 128 of target node 104 and, ultimately, child leaf nodes 132 of target node 104.

As best seen in FIG. 4, data structure 100 consists of a plurality of records, each identifying one parent-child relationship 136, 140. Each record has five fields identifying the parent node, the child node, the nodal distance between the parent and child nodes, whether the parent node is a root node and whether the child node is a leaf node. Table 1 with records for each relationship shown in FIG. 4 is presented in FIG. 5.

An exemplary set of SQL DDL code to create Table 1 for the graph data structure of FIG. 4 is presented in Appendix 3. While the sample code presented in Appendix 3 and other code illustrated hereafter are presented in a particular language, it will be understood by those of skill in the art that there a number of other languages or pseudo-languages that can be used to achieve the same results.

In the data model shown in Table 1, the distance attribute shows the length of a path from a given target node to any of its parent or child nodes. For instance, the distances between target node 104 and nodes 124A, 124B and 124C in FIG. 4 are one; the distances between target node 104 and node 112A, 112B and 112C are two; and the distances between target node 104 and node 132A, 132B and 132C are “n”.

The attributes, ‘isParentRoot’ and ‘isChildLeaf’, are Boolean values, indicating if the parent node is a root node or if the child node is a leaf node.

Based on the above data model, given a particular target node, operations for performing a number of data retrievals become more simplified and efficient. As a result of having a record for each direct and indirect parent-child relationship, a single query to database 52 can provide results that will answer a number of questions. For example, the prior art sample code presented in Appendix 2 for performing the operation of searching a target node “i”'s child nodes at a specified level is simplified, as evident in the sample code presented in Appendix 4, as a result of the modified data model.

The pseudo-code of Appendix 4 can also be applied to search the target node's parent nodes at a nodal distance m, where m is a positive integer, with the minor change of sqlString as noted in Appendix 5.

Given a particular target node, searching either all its parent nodes or child nodes can be done with the two exemplary simple SQL query strings presented in Appendix 6. Again, all the other processing is the same and omitted.

Searching the leaf or root nodes of a target node can be done by using the exemplary query strings presented in Appendix 7.

Where it is desired to determine whether two nodes are related, the exemplary simple query string presented in Appendix 8 can be used.

If the above search returns any results, node i and j are related; that is, they have parent-child relations. Otherwise they are not related. In the case where the data structure represents a family tree, this last data retrieval can determine if two people are related.

In order to enable such data retrieval operations as noted above, the data structure must be created. Further, during the course of such a data structure's lifetime, it is likely that modifications to it may be required. Creation or modification of such a data structure is typically performed one node at a time. In such cases, where a data structure is being added to, a child node is added to an already existing parent node in the data structure, unless a new parent root node is being added.

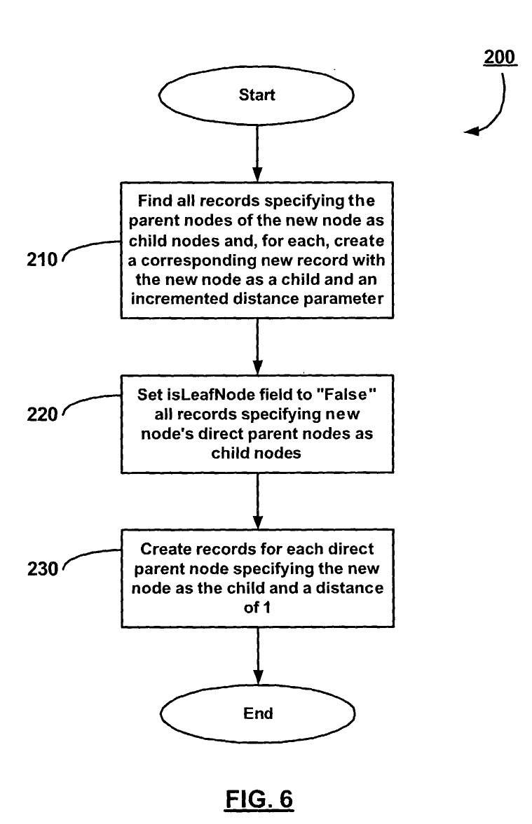

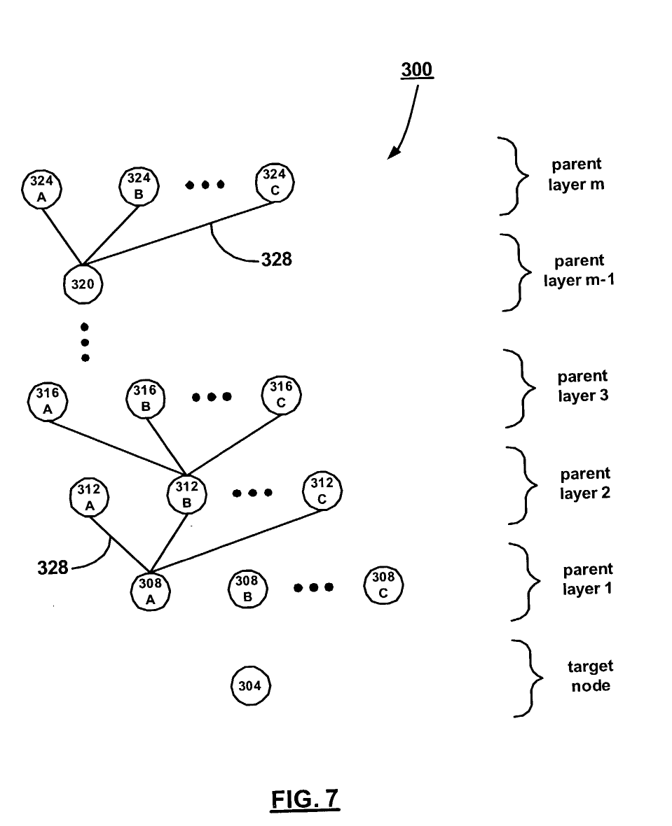

Now referring to FIG. 6, a method of adding a child leaf node is shown generally as 200. To assist in explaining method 200, reference will be made to FIG. 7, which shows an exemplary new child node 304 for placement in an exemplary graph data structure 300. Graph data structure 300, of which a portion is shown, has m layers: three exemplary top-level parent root nodes 324A, 324B and 324C; m−1 layers of a number of child leaf nodes that include three exemplary bottom-level child leaf nodes 308A, 308B and 308C; and a number of parent-child relationships 328. In this particular example, it is assumed that the user has decided that new node 304 will have a number of parent nodes, including nodes 308A, 308B and 308C.

At step 210, database 52 is queried for all records specifying parent nodes 308 as child nodes. This step is done to determine what relationships will need be recorded for new node 304. That is, if parent node 308 of new node 304 has direct or indirect child relationships with a number of nodes, new node 304 will also have indirect child relationships with each of these. The results for each parent are then merged.

In cases where two parent nodes 308 themselves share a common direct or indirect parent node, it can be desirable to only add one record specifying the parent node's relationship to new node 304. In an exemplary graph data structure in accordance with a particular embodiment of the present invention, where it is not possible to have two paths between a child node and a parent node of different lengths, that is, where the path passes through one and only node at each level, it can be advantageous to maintain only the fact that the parent and child nodes are related and not how many paths exist between the two nodes. In such cases, records with duplicate parent nodes can be removed.

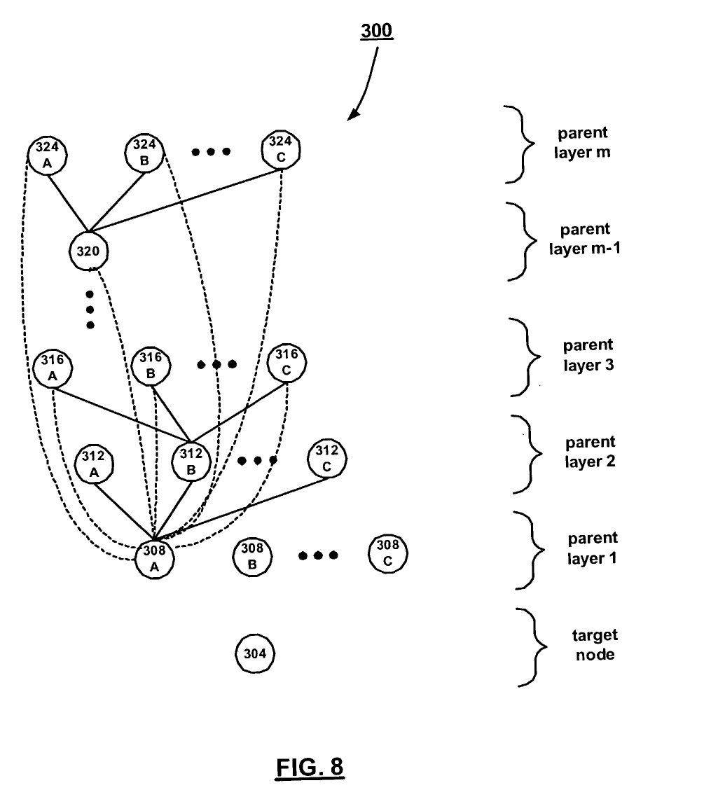

The relationships specified by these processed records are illustrated in FIG. 8.

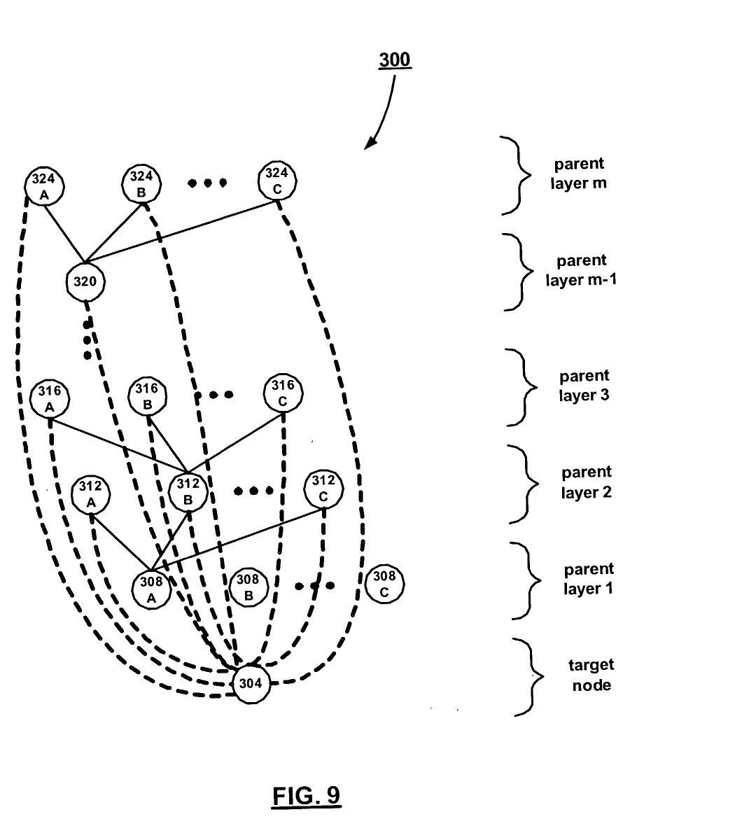

The copies of the records returned and processed are then altered by replacing the child node reference with the new node's ID and by incrementing the distance by one. These records are then submitted to database 52 as new records. FIG. 9 illustrates the relationships represented by the new records.

At step 220, all records specifying parent nodes 308 of child node 304 as child nodes are reviewed and, where nodes 308 are indicated to be child leaf nodes, the records are altered to specify that parent nodes 308 are no longer leaf nodes. In a present embodiment, this is done by setting a Boolean flag called “isChildLeaf” to false. This step can be performed independently of step 210, but it may be advantageous to store a separate copy of the records specifying nodes 308 as child nodes so that these records can be reviewed and modified and reinserted into database 52 where changes are required.

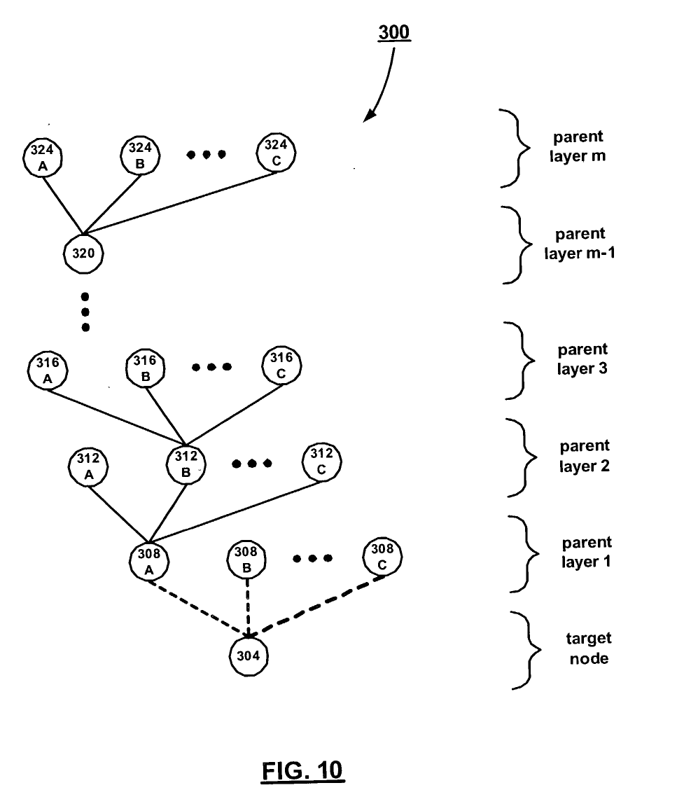

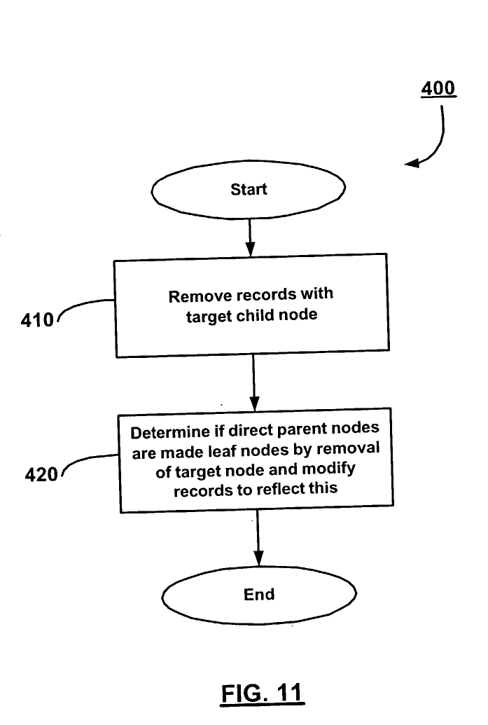

At step 230, a set of records are generated for the parent-child relationships between new node 304 and parent nodes 308 specified by the application or user, including three exemplary parent nodes 308A, 308B and 308C, as shown in FIG. 10. The set of records generated for the parent-child relationships between new node 304 and parent nodes 308 is then added to database 52.

In an embodiment of the invention, a stored copy of all records specifying parent nodes 308 of new node 304 as child nodes is used to determine which of parent nodes 308 are root parent nodes. This is indicated by a parent node 308 not being listed as a child node in any records of database 52. This information is particularly useful where a particular graph data structure allows for a path of parent-child relationships to skip one ore more levels. This information is then used to construct the records between parent nodes 308 and new node 304. Alternatively, a record can be added to database 52 for each parent root nodes specifying them as child nodes and a null parent node.

Once these records have been entered into database 52, the process of adding new node 304 to data structure 300 is complete. The sample code presented in Appendix 9 illustrates these steps. Upon receipt of this command, the database server queries database 52 for a copy of all records specifying as child nodes any of parent nodes 308 specified for new node 304. The database server then replaces parent nodes 308 in the child node field with new node 304, increases the distance parameter by one and inserts the new records into database 52.

Now referring to FIG. 11, a method of removing a child leaf node is shown generally as 400. At step 410, database 52 is directed to remove all records referring to the node to be removed.

At step 420, the database is searched for records specifying the former parent nodes of the removed node as parent nodes. Each former parent node not indicated to be a parent node by the remaining records is, as a result of the node removal, made a child leaf node. For each of these new child leaf nodes, each record specifying them as child nodes are modified to reflect their new leaf node status.

Once all of these records have been removed, the graph data structure has been modified to reflect the removal of the node.

While the embodiments discussed herein are directed to specific implementations of the invention, it will be understood that combinations, sub-sets and variations of the embodiments are within the scope of the invention. For example, while the particular graph data structures used for purposes of illustrating the invention are hierarchical quasi-tree data structures, it will be understood by those of skill in the art that the data modeling methods can be applied to a number of other graph data structures. For example, graph data structures where there can be two paths between a parent and child node of different lengths can be represented by the data modeling methods described herein. In such cases, it can be desirable to maintain two or more records to characterize the relationship between the parent and child node.

While the records of database 52 describing the relationships of the data structure are illustrated with the fields, parentNodeID, childNodeID, distance, isParentRoot and isChildLeaf, other record layouts can be desirable in other situations. Where the sole purpose of an application is to determine whether there is a direct or indirect parent-child relationship between two nodes, the records can consist of only the first two fields noted above. In other cases, where it is not important to find parent root nodes or child leaf nodes, it can be desirable to have the records only have the first three of the fields noted above.

Further variations can include modeling travel routes between various cities. In such cases, the cities are represented by nodes and the links can represent legs of a journey. Distance in the previous examples can be replaced with the statistics of travel time and cost. In the modern world of travel, where there are thousands of flights per day, it can be advantageous to quickly determine if a link exists between two cities, regardless of the number of legs, how much time will be required to make the journey and how much will the journey cost.

In addition, critical path methods (CPMs) and performance evaluation and review techniques (PERTs) can be modeled using the methods described above, allowing resources to be tracked similarly to distance in the previous examples and relations between tasks, known as dependence, can be quickly determined.

It is noted that it can be advantageous in some cases to maintain relational data for selected relations. For example, it may only be important to know the parent root nodes and child leaf nodes of a given node.

It is contemplated that server 24 and client 28 can reside on a single physical machine or cluster of machines. Alternatively, server 24 and database 52 can be distributed across a number of computers that can be remotely connected.

Further, client 28 can be an application server that provides functionality to a number of secondary clients.

The present invention provides a novel system and method for storing and retrieving data. By recording relational information between non-proximal nodes, a system of the like described herein is advantageous over prior art data models that require multiple nested database queries that are resource-intensive, occupying an undesirable amount of memory or consuming a large number of processor clock cycles. A variety of data retrieval operations can be simplified to one declarative database query, with a reduction in need of complex procedural language processing. The simplification of code required to perform a number of data retrievals can lead to reduced development efforts and time, resulting better code reusability and maintainability.

The above-described embodiments of the invention are intended to be examples of the present invention and alterations and modifications may be effected thereto, by those of skill in the art, without departing from the scope of the invention which is defined solely by the claims appended hereto.

[image]

[image]

[image]

[image]

[image]

[image]

[image]

[image]

[image]

[image]

[image]

We claim:

1. A system for storing and retrieving data, comprising:
at least one client for connection to a database server and for retrieving and presenting a subset of a set of data stored on said database server;
said set of data representing a set of records, that represent at least a first node and a second node, and at least one characteristic of a relationship between said first node and said second node.

2. The system for storing and retrieving data of claim 1, wherein said at least one characteristic includes a distance metric of said individual between said first node and said second node.

3. The system for storing and retrieving data of claim 2, wherein said distance metric is a measure of nodal distance between said first node and said second node.

4. The system for storing and retrieving data of claim 2, wherein said distance metric is a measure of physical distance between said first node and said second node.

5. The system for storing and retrieving data of claim 1, wherein said at least one characteristic includes a measure of time associated with said individual relationship between said first node to said second node.

6. The system for storing and retrieving data of claim 1, wherein said at least one characteristic includes a measure of financial cost associated with said individual relationship between said first node to said second node.

7. The system for storing and retrieving data of claim 1, wherein each of said records additionally represents at least one characteristic of said first node.

8. The system for storing and retrieving data of claim 1, wherein each of said records additionally represents at least one characteristic of said second node.

9. The system for storing and retrieving data of claim 1, wherein each of said records represents one of a set of direct and indirect parent-child relationships of said graph data structure, said first node is a parent node and said second node is a child node.

10. The system for storing and retrieving data of claim 9, wherein said at least one characteristic includes a distance metric of said individual relationship between said first node and said second node.

11. The system for storing and retrieving data of claim 9, wherein each of said records additionally represents at least one characteristic of said first node.

12. The system for storing and retrieving data of claim 11, wherein said at least one characteristic includes a flag indicating whether said first node is a root parent node.

13. The system for storing and retrieving data of claim 9, wherein each of said records additionally represents at least one characteristic of said second node.

14. The system for storing and retrieving data of claim 13, wherein said at least one characteristic includes a flag indicating whether said second node is a child leaf node.

15. The system for storing and retrieving data of claim 1, wherein said client is an application server serving at least one secondary client.

16. The system for storing and retrieving data of claim 1, wherein said database server and said client reside on a single physical machine.

17. A system for storing and retrieving data, comprising:
a database server having a database for storing a set of data from a graph data structure;
at least one client for retrieving a subset of data from said graph data structure stored in said database;
said database comprising a set of records, each of said records representing an individual parent-child relationship between a parent node and a child node and having a first field specifying said parent node, a second field specifying said child node, a third field specifying whether said parent node is a parent root node, a fourth field specifying whether said child node is a child leaf node and a fifth field specifying the nodal distance between said parent and child nodes.

18. A method of storing data, comprising the steps:
recording a set of direct node relationships between a set of nodes forming a graph data structure;
recording a set of indirect node relationships between said set of nodes; and
combining said set of direct node relationships and said indirect node relationships to form a database of direct and indirect node relationships.

19. The method of storing data of claim 18, wherein each of said direct node relationships represents a relationship between a first node and a direct parent node of said first node and each of said indirect node relationships represent a relationship between a second node and an indirect parent of said second node.

20. A method of adding a node to a graph data structure stored in a database, comprising the steps:
retrieving from a database a first set of direct and indirect node relationships for a first set of nodes to which a new node is to be directly related;
recording in said database a second set of indirect relationships between said new node and a second set of nodes related to said first set of nodes as indicated by said set of direct and indirect node relationships; and
recording in said database a third set of direct relationships between said first set of nodes and said new node.

21. The method of adding a node to a graph data structure stored in a database of claim 20, wherein each of said first, second and third sets of direct and indirect node relationships, each specifying a relationship between a first node and a second node, additionally comprise at least one characteristic of said relationship between said first node and said second node.

22. The method of adding a node to a graph data structure stored in a database of claim 21, wherein said at least one characteristic includes a distance metric between said first node and said second node.

23. The method of adding a node to a graph data structure stored in a database of claim 21, wherein said distance metric is based on nodal distance between said first node and said second node.

24. The method of adding a node to a graph data structure stored in a database of claim 20, wherein said graph data structure is hierarchical and said first, second and third sets of direct and indirect relationships represent direct and indirect parent-child relationships between a parent node and a child node.

25. The method of adding a node to a graph data structure stored in a database of claim 24, wherein said database additionally stores at least one characteristic of each of said first, second and third sets of direct and indirect parent-child relationships.

26. The method of adding a node to a graph data structure stored in a database of claim 25, wherein said at least one characteristic includes a distance metric of a relationship between said first node and said second node.

27. The method of adding a node to a graph data structure stored in a database of claim 26, wherein said distance metric is a measure of the nodal distance between said first node and said second node.

28. The method of adding a node to a graph data structure stored in a database of claim 24, wherein each of said first, second and third sets of direct and indirect node relationships additionally include at least one characteristic of said first node.

29. The method of adding a node to a graph data structure stored in a database of claim 28, wherein said at least one characteristic includes a flag indicating whether said first node is a parent root node.

30. The method of adding a node to a graph data structure stored in a database of claim 24, wherein each of said first, second and third sets of direct and indirect node relationships additionally include at least one characteristic of said second node.

31. The method of adding a node to a graph data structure stored in a database of claim 30, wherein said at least one characteristic includes a flag indicating whether said second node is a child leaf node.
